(19) United States
(12) Patent Application Publication
(10) Pub. No.: US 2012/0265692 A1
(43) Pub. Date: Oct. 18, 2012

(54) SYSTEM AND METHOD FOR PROJECT ESTIMATES

(76) Inventor: Gerald Gerber, Ballwin, MO (US)

(21) Appl. No.: 13/443,970

(22) Filed: Apr. 11, 2012

Related U.S. Application Data
(60) Provisional application No. 61/475,598, filed on Apr. 14, 2011.

(51) Int. Cl. G06Q 10/06

(52) U.S. Cl. 705/301

(57) ABSTRACT

A system for providing timely and accurate proposal estimates comprising of at least three computers connected to the internet, wherein all users, through the use of a web-based system, are simultaneously connected to one database, for the purpose of providing integrated specifications and bids placed by tradesmen and material suppliers, along with overhead and profit markups submitted to a residential or commercial client. A system administrator or system manager assigns users to projects initiated by the base system. By uploading documents, plans, and pictures and assigning them to the appropriate users, when used in conjunction with the estimate module, create a complete set of estimation documentation for use in an integrated labor and material installation.

### CROSS-REFERENCE TO RELATED APPLICATIONS

This application claims priority to U.S. Patent Application Ser. No. 61/475,598 filed on Apr. 14, 2011 and having the title “SYSTEM AND METHOD FOR PROJECT ESTIMATES”, which is herein incorporated in its entirety.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to the coordination of estimates and bids for work projects, and more particularly to a project coordination database that is managed by a system administrator and simultaneously accessible through a computer network by project managers, suppliers and customers.

2. Related Art

There are currently inconsistencies between project bid systems and project management systems. Project management systems typically allow contractors to manage various project phases (e.g., kitchen, bath and addition in a home remodeling project) with multiple divisions within the various phases (e.g., planning, site work, demolition, concrete, etc.). These various project phases may be the subject of multiple specifications for the divisions, but the general contractor is working to an overall project budget. However, current bid systems that contractors use with their customers and sub-contractors fail to provide for such project phases and divisions all within the same overall project budget so there remains a significant manual process to coordinate, organize and prepare budget estimates.

### SUMMARY OF THE INVENTION

The system of the present invention provides timely and accurate proposal estimates comprising of at least three computers connected to the internet, wherein all users, through the use of a web-based system, are simultaneously connected to one database for the purpose of providing integrated specifications and bids placed by tradesmen and material suppliers, along with overhead and profit markups submitted to a residential or commercial client. A system administrator or system manager assigns users to projects initiated by the base system. By uploading documents, plans, and pictures and assigning them to the appropriate users, when used in conjunction with the estimate module, a complete set of estimation documentation is created for use in an integrated labor and material installation.

None of the existing software products have a single screen user interface, like our system. This is the unique part of the invention. The project administrator/manager controls the design of the estimate, all specs, alternates, and categories. When a user is invited into the system, he sees all of the specs, and bids on those that apply to his abilities. The manager can select the bidders on the main screen, and see the complete bid amount before alerting the owner that the estimate is ready. We avoid problems with bid specs not being transferred, because the client uses the exact same specs as the bidder sees when placing their number. With copy and paste, the manager can use specs from the bidder, and when accepted, they become part of the estimate with the owner.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a block diagram of the system users with a flow of information.

FIG. 2 illustrates an estimate overview flow chart.

FIGS. 3A-3C illustrate the contrast between current systems and the present invention.

FIG. 4 illustrates the main functions of the present invention in a schematic flowchart.

FIG. 5 illustrates the item addition detail from FIG. 4.

FIG. 6 illustrates the editing/deleting item detail from FIG. 4.

FIG. 7 illustrates the biddable item editing detail from FIG. 6.

FIGS. 8A-8S are screen shots that illustrate the operation of the present invention.

### DETAILED DESCRIPTION OF THE PREFERRED EMBODIMENTS

The following description of the preferred embodiment(s) is merely exemplary in nature and is in no way intended to limit the invention, its application, or uses. The present invention solves a problem of the specifications that are written for a project, what is actually bid, and what is further presented to the client for retail sale. A novel aspect of the invention is allowing, in a real time nature, the viewing of the same spec and pricing by all interested parties to a project (managing contractor, trades/bidders & homeowner/buyer). By using one web page document to house all information, the information that is specified on the project manager's pages is immediately available for viewing by the client and the tradesmen submitting bids. There is no e-mail or other transfer of information required outside of the project bid system. The specs bid are marked up, and the client has a priced screen to view. This is all done by the invention through coding and calculations, screen building and attached electronic documents.

The invention improves on the processes that are currently used for bid procurement. Presently available bid procurement systems do a thorough job of detailing the items, but then pass them to the bidders, who in turn produce the prices back to the source, many times in their own formats. A data person must then manually enter the prices into the system (either by key in or cut & paste) and tabulate the numbers for a presentation to the client. In comparison, with the present invention, a vendor user that wants to bid on a project would submit the quoted price estimate online, adjacent to the specification area, and the bid data is sent to the server and immediately available for view by the manager. In the current systems, users transfer information and pricing from multiple systems, whereas the present invention avoids errors in typing or specification comprehension.

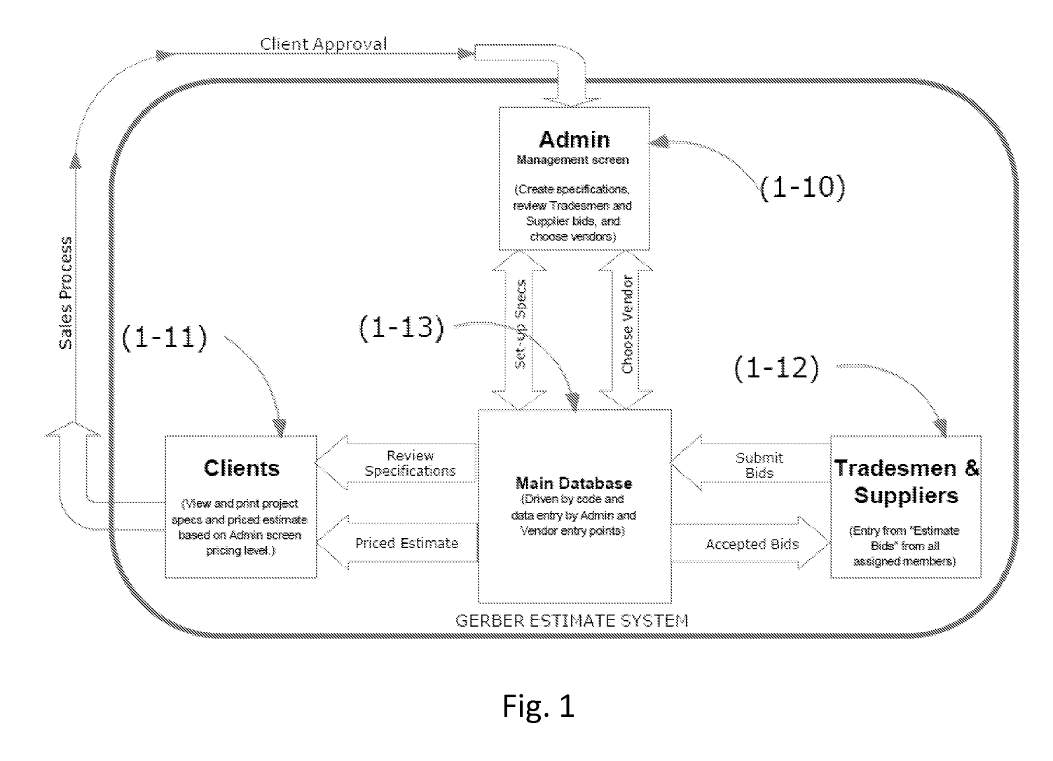

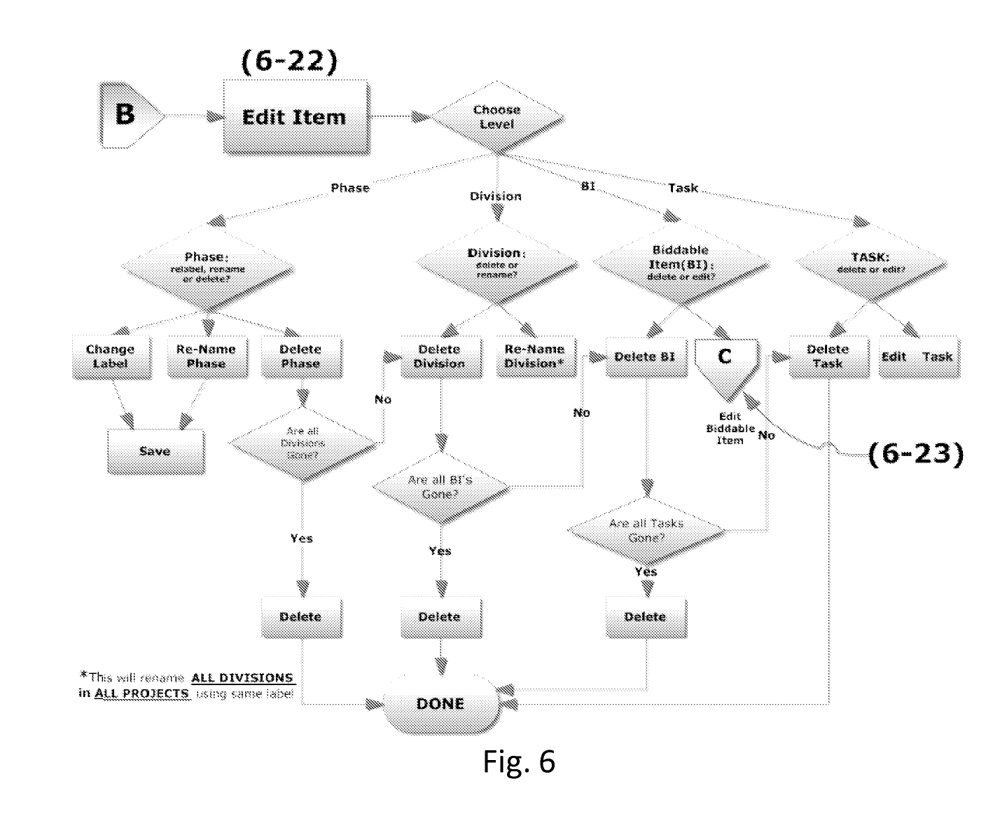

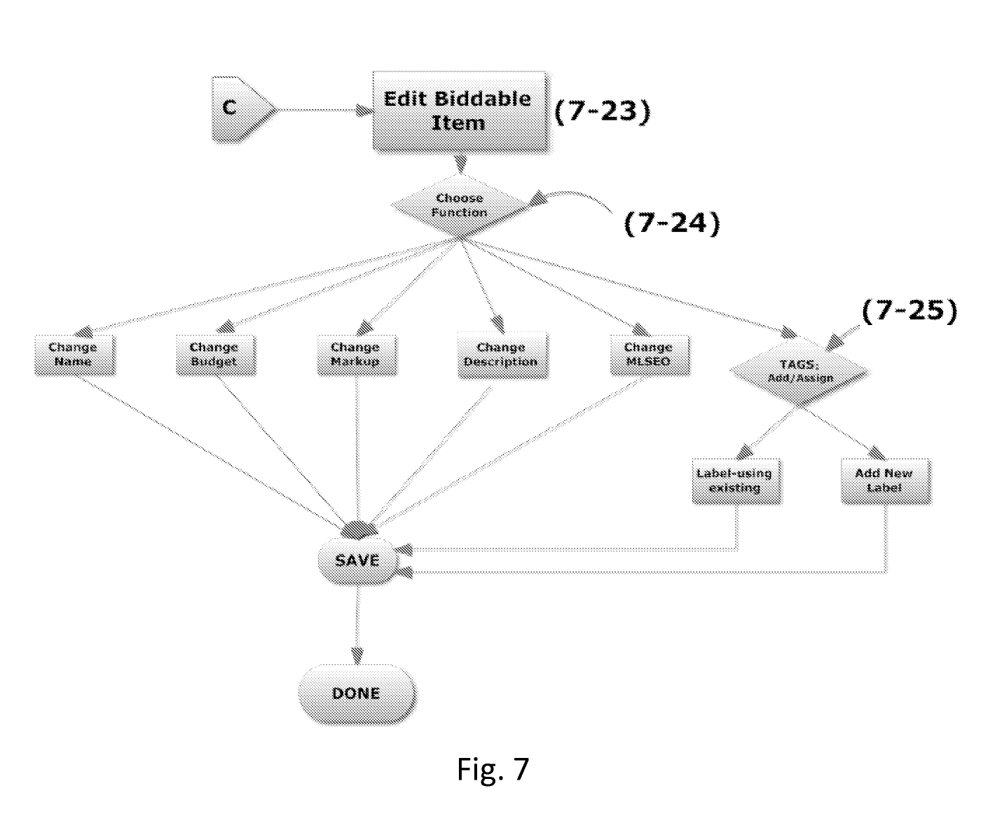

The estimator module of the system is illustrated in FIGS. 1-7 and described in detail below with reference to each one of the illustrations. The estimator module receives data from a base program that stores client, tradesmen, and supplier information through multiple set-up points. The primary function of the base program is as a communication tool between the contractor, the trades, and the clients through the storing and sharing of documents, pictures, and architectural drawings used as reference for the project Estimates. The system does not require the passing back and forth of documents, but rather the documents are available to each party at their respective locations. The base program has a single database and provides standard project management features, such as document notification, project specific security, and six (6) security levels which allow access to the “grid” by only administrator selected projects.

Referring to the accompanying drawings in which like reference numbers indicate like elements (page#-item#), FIG. 1 shows the three components that make up an estimated project. The Administrator or project managers, labeled Admin, (1-10), initiate all functions of an estimate. Prior to the design and writing of an estimate, Tradesmen/Suppliers (1-11) & (1-12) are assigned as project members through a selection process inside of the base software program. This is done by a project Manager or Administrator.

All project members have been selected in earlier stages by project notification. After receiving an invitation to view documents, pictures and plans, each user is requested to “sign-up” interest to participate in bidding the project. They indicate their schedule availability and interest in bidding the project. The notifications occur through cellular telephone SMS services and e-mail with a hyperlink directing the user to login to the system with their unique login name and password. This gateway is used to access information in the base system and consequently in the estimate module invention. At login, variables in the database tell the system whether the user is a Client (1-11) or a Vendor (1-12). The estimate system calls for a user variable from the Main Database/Server (1-13), as each screen is compiled and sent to the correct user's computer screen.

There is also a Contractor level of user, which is assigned by the Manager to individual projects in the base system. Once a Vendor user (1-12) is considered the Contractor for a specific project, he has the same permission levels inside that project estimate as the System Managers have in all projects.

All users are granted permission levels and access to their specific projects in the base system module. Each project specific menu contains a hyperlink to the estimate area for estimate participation. As the workstation calls the server to access the estimate, the system accesses the database and determines which screen view will be loaded, by the security permissions given to each user.

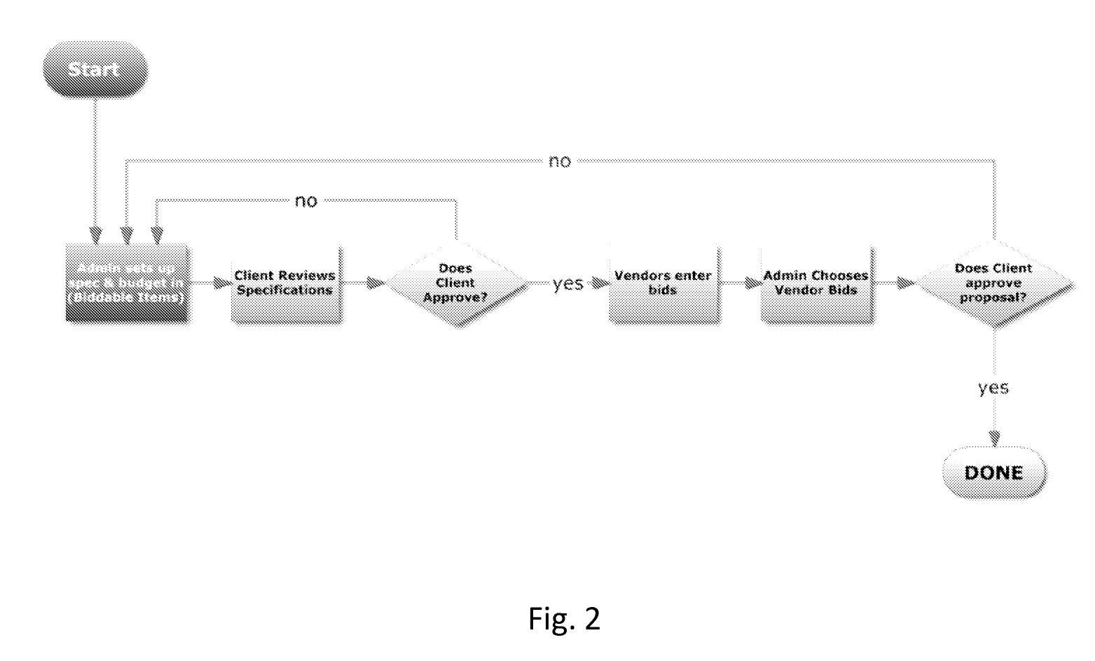

FIG. 2 shows a simplified overview of the steps that are performed in the estimate system. Through the creation of specifications, client review, entering bids, vendor selections, and client approval of the estimate, a project is then off to scheduling for material order and labor implementation. This system, while complete as a module, requires access to plans, pictures, and correspondence from a base program.

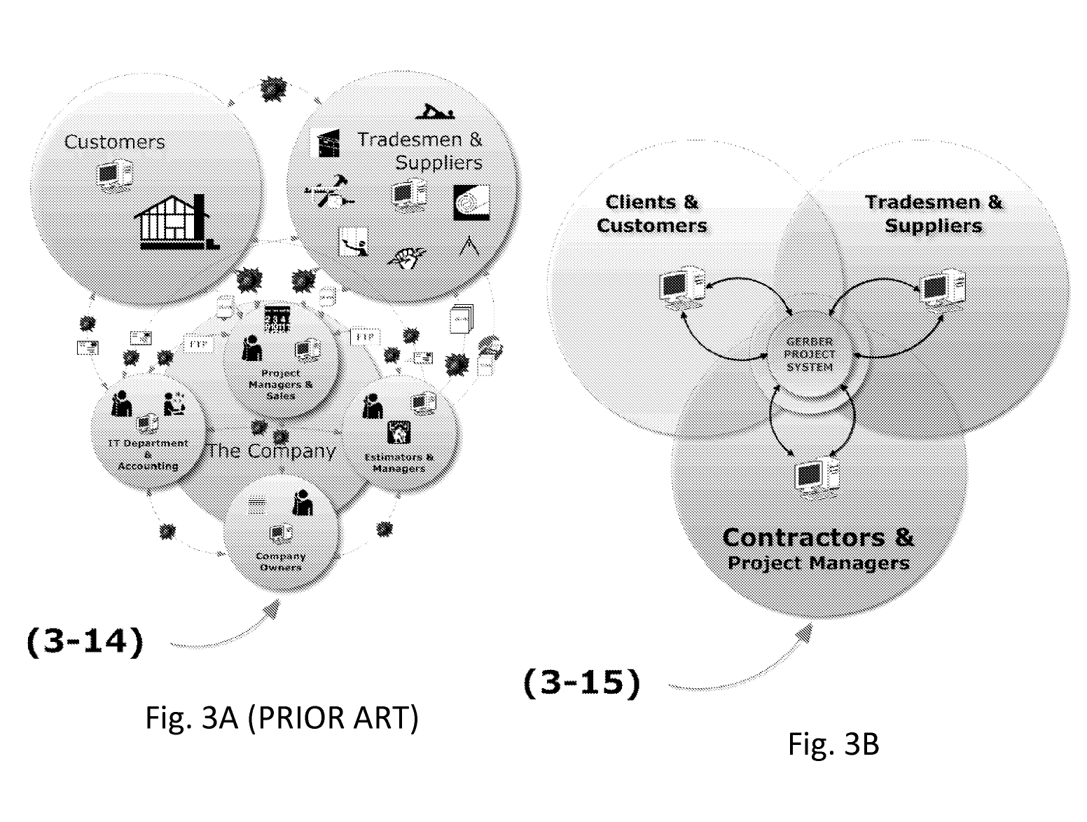

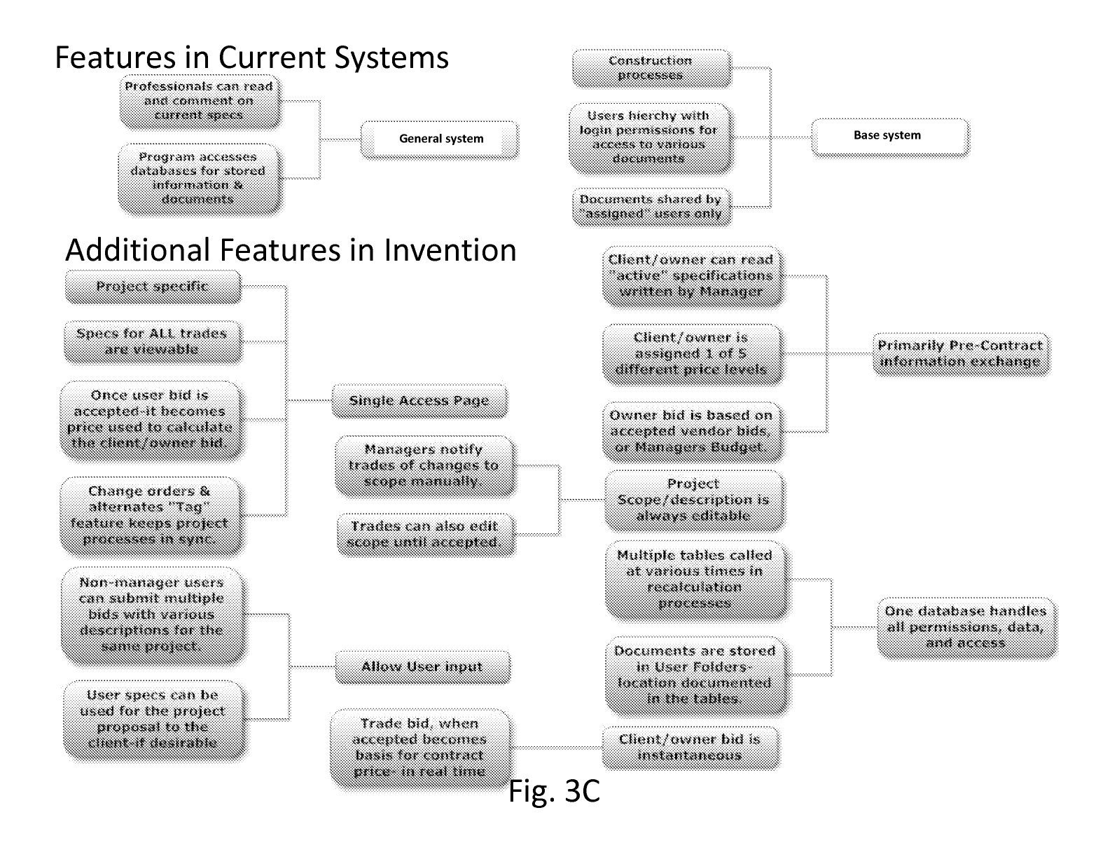

FIG. 3A shows a typical workflow using current management and estimating methods (3-14) and is contrasted with the streamlined methodology of the present invention, which is shown in FIG. 3B. In current systems, the transferring of vital project estimate and production information is clumsy at best. The flow of information (3-15) provided by the invention, allows project specifications, plans, and general communication to arrive in one organized system, providing uninterrupted (24/7) access to Company Managers, Tradesmen, Suppliers, and owner Clients to all documents, estimates, and communication.

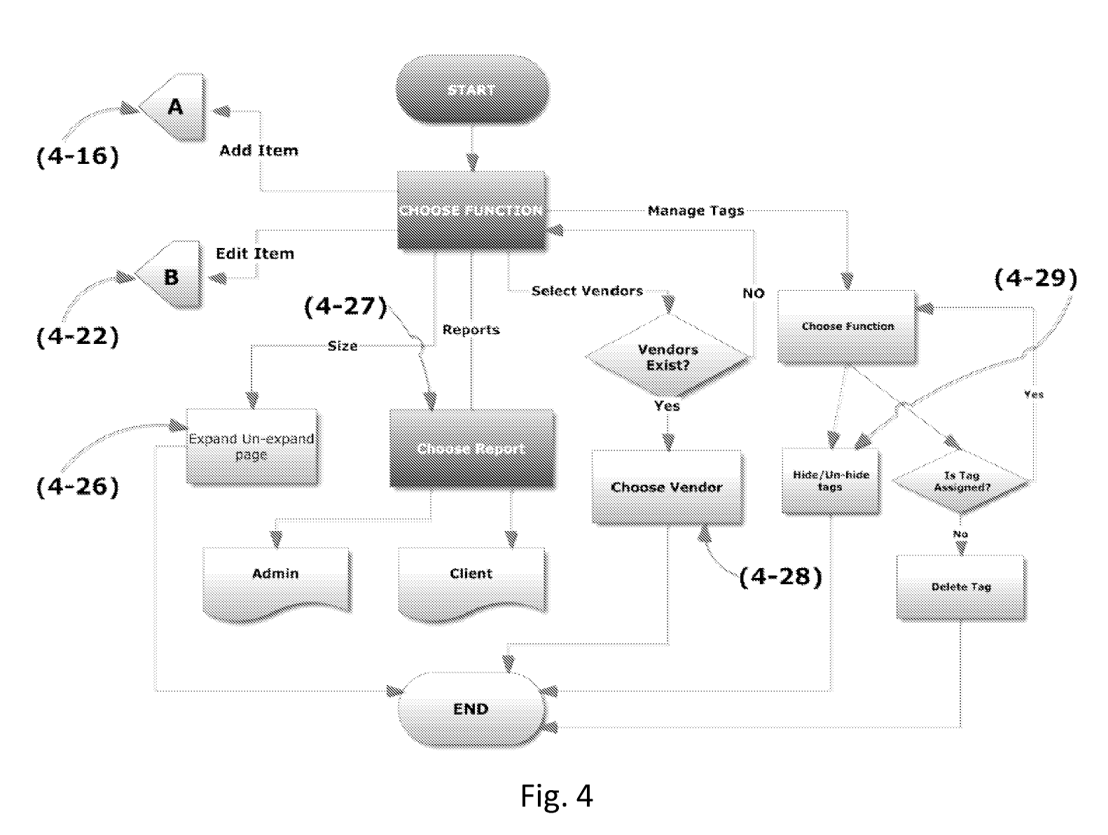

FIG. 4 provides an overview of the functions that are available on the main control page of the present invention, when the system is operated by a user with permissions of the project manager. An estimate can be viewed as Expanded or as Unexpanded (4-26). This allows Phase headings and Division totals to show in sub-totaled form. There are reports available from the Admin view (4-27) that use totals from whatever is displayed on the screen. The Client report can be used for proposal documentation that is supported by actual bids and mark-ups inside of the Biddable Items. Vendor selections can only take place if there is a Vendor bid for a particular Biddable Item (BI) (4-28). If the budget applied to a BI is greater than 0, then that number is used in the calculation of the budget and price for the BI.

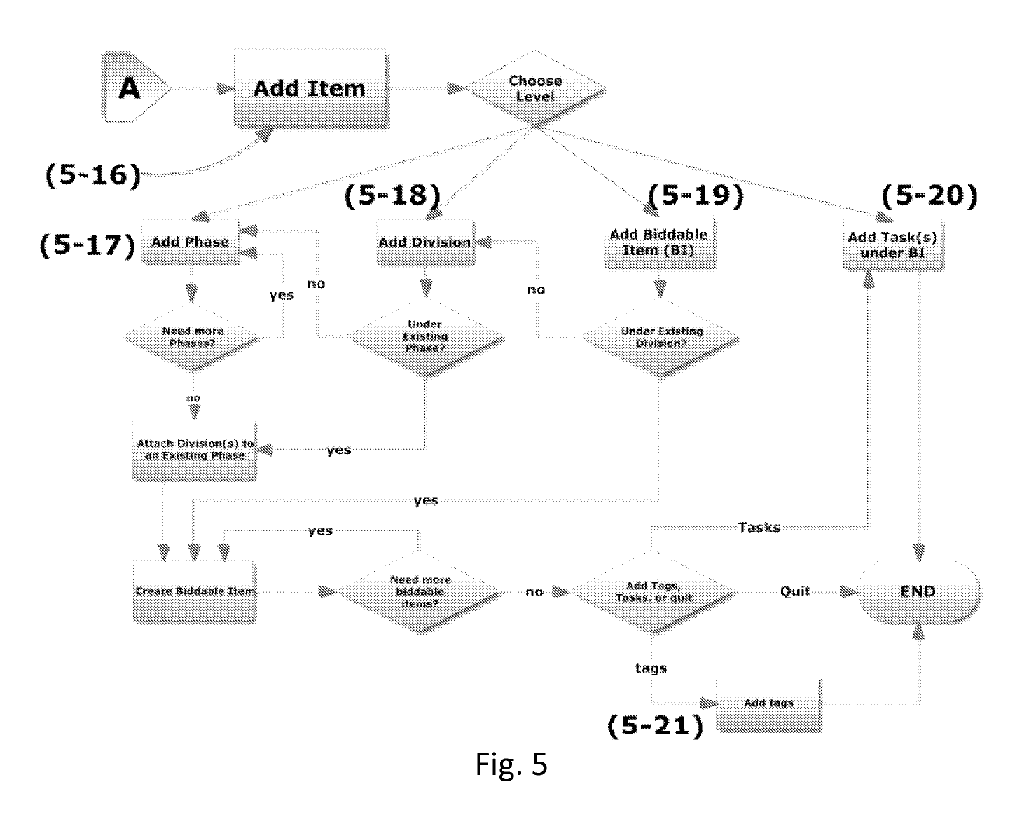

As discussed in further detail below with reference to FIG. 5, each Biddable Item can have a “Tag” (4-29)/(5-21) attached to it. A user can apply a new Tag at any time which will then be available for all BI's in the particular project. Tags are always project specific.

The first function chosen in FIG. 4 is to create an estimate by Adding an Item (4-16)/(5-16). When the estimate is launched for the first time from the base system, it is completely blank, with the exception of the header/banner and tools icon. The system program (catcher.php) instructs the program to access the database, loading the screen with the correct template based on permission levels.

Each project has at least one Phase (5-17), and each Phase has at least one Division (5-18) and one Biddable Item (5-19). We will be demonstrating in detail the program from the view of the Administrator. The Vendor and Client views are somewhat similar, yet simpler, and contain exactly the same specification data entered from the Admin screen. The use of the same core data for both the Vendor and the Client is one of the key features of the invention because, as discussed above, this avoids the risk of typographical errors or other potential sources of error that could result in an inaccurate quote being generated for a Client. The Vendors submit their bids for each Biddable Item and run reports as well as billing submittal forms. Once selected by Admin, a Vendor's bid is calculated into the Client estimate with pre-determined markups derived from the Biddable Item. The estimate divisions are pre-defined, yet editable. New divisions and names can be added at any time.

Through initial training and “demos”, a Manager/Estimator is instructed to use the “Tools” menu, where there are 4 selections, one of which is to add a Phase. The Add Phase (5-17) box appears where a user can assign a symbol which will sort the Phases in an alpha sort order, and a brief description of each Phase. (e.g., Kitchen, Bath, Addition, etc.). The Phases are designed by the project Manager/Estimator.

When the user has finished adding Phases, they appear on the screen in sorted order. There is a plus symbol adjacent to a description where the user can add Divisions (5-18). After the divisions are selected (e.g. planning, site work, demolition, concrete, etc.) the user has an option to create Biddable Items (5-19). Biddable items (BI) are used to transfer bid items from the Vendors into estimates available to the Client. There is also a Task listing associated with each BI. When refreshed, the “Tasks” (5-20) are sorted in alpha-sort under each BI. They do not carry any estimate value. Each Biddable Item (BI) entry requires a selection for Material, Labor, Sub, Equipment, or Other categories. This assignment is used for reports generated for material selections, labor estimates, and Subcontractor assignments and information.

When there is a need to break out a total for a change order, or estimate alternative, there is an option called “Tags” (5-21). Tags can be created while editing a Biddable Item. Under the tools menu, “Tag Management” allows Admin to “Hide” or “Show” each grouping of tags. All items hidden on the main Admin screen will subsequently be hidden from the Client and Vendor screens, keeping all specifications in perfect synchronization. Totals recalculate when tags are hidden, and do not show in Vendor or Client pages.

As a continuation of FIG. 4, the second function from the main screen is Edit Item (6-22)/(4-22). Each item on the screen is editable by clicking on the description of any item on the screen. For safety, all tasks, biddable items, and divisions must be deleted (in reverse order) prior to deleting a Phase. A user can serve the same function by applying a Tag to a group of items, and hiding the Tag. Then, the items and all associated bids can be brought back to the estimate. Editing a Biddable Item (6-23)/(7-23) is typically the most used sequence.

All item names, and descriptions can be edited (7-24). An Admin user can make multiple alternates using the Tag (7-25) feature.

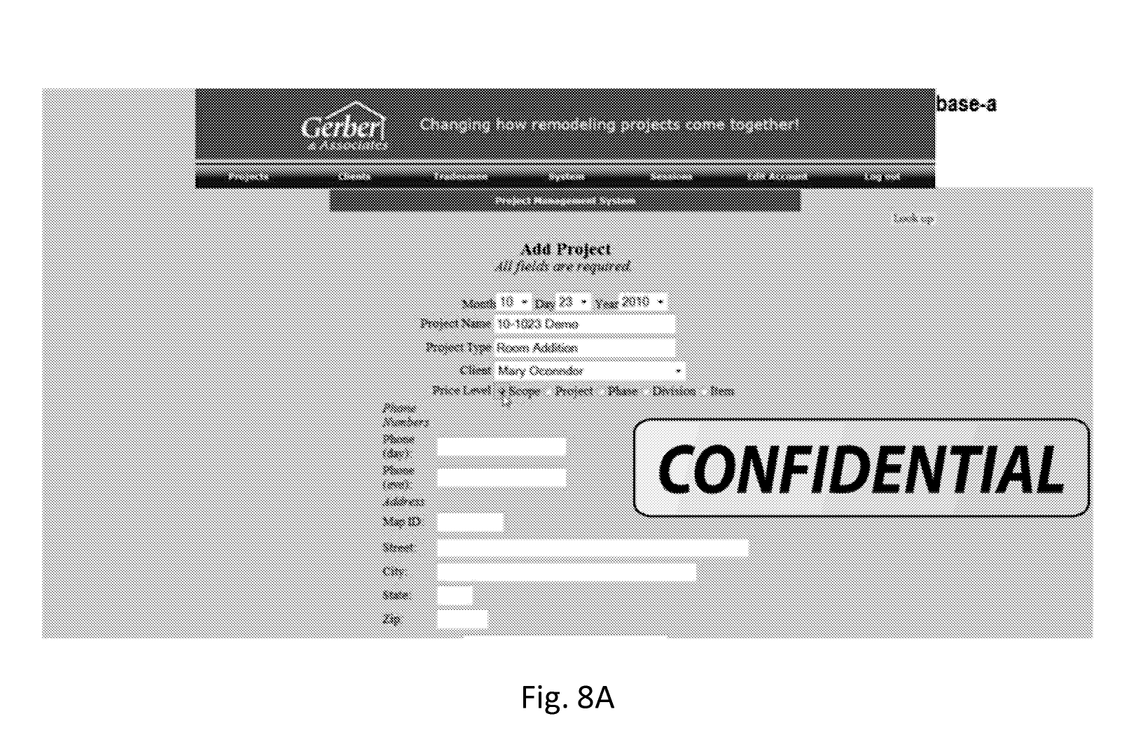

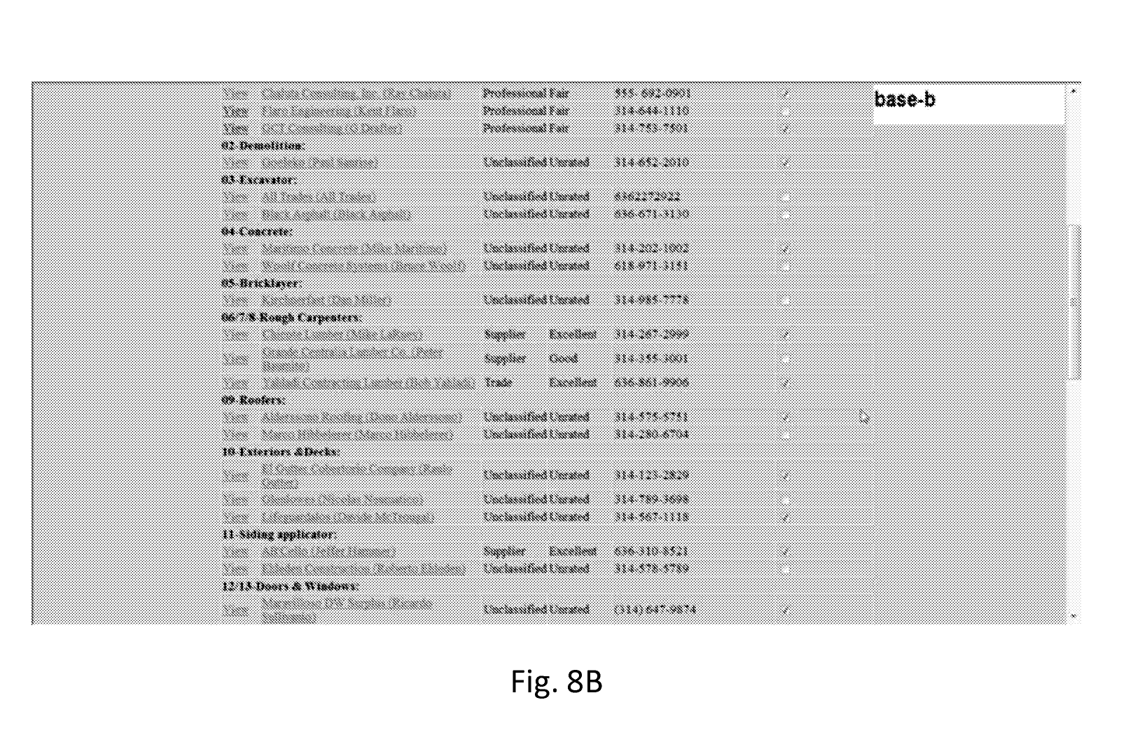

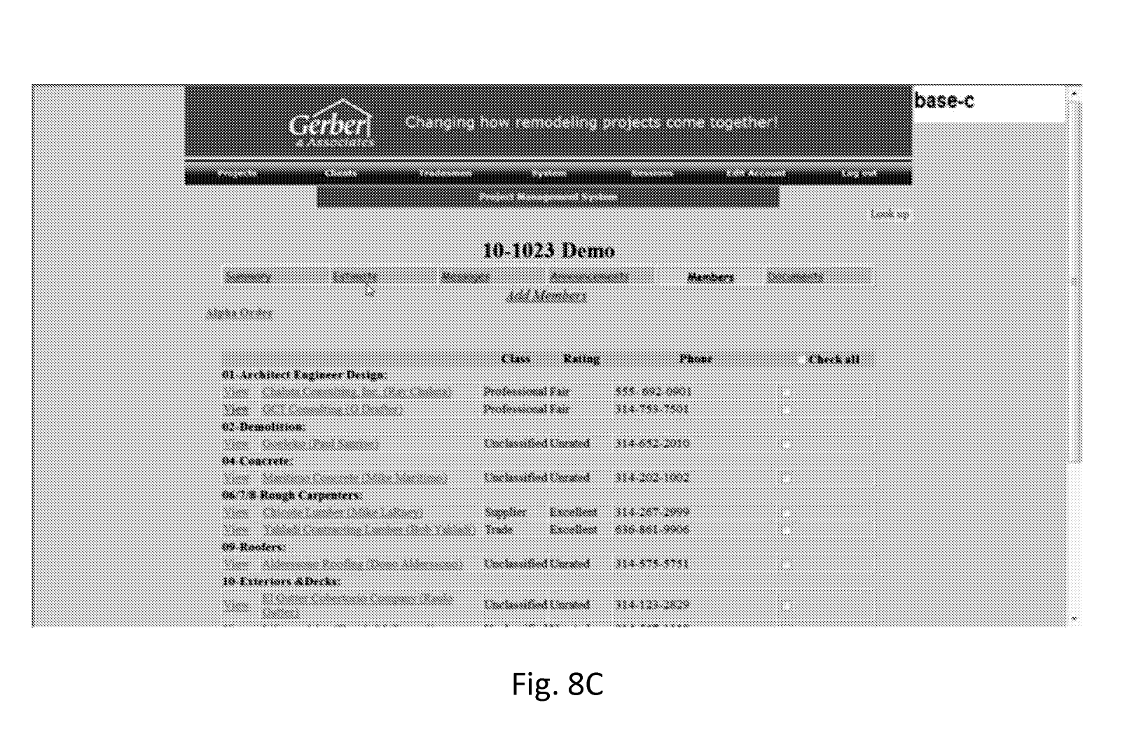

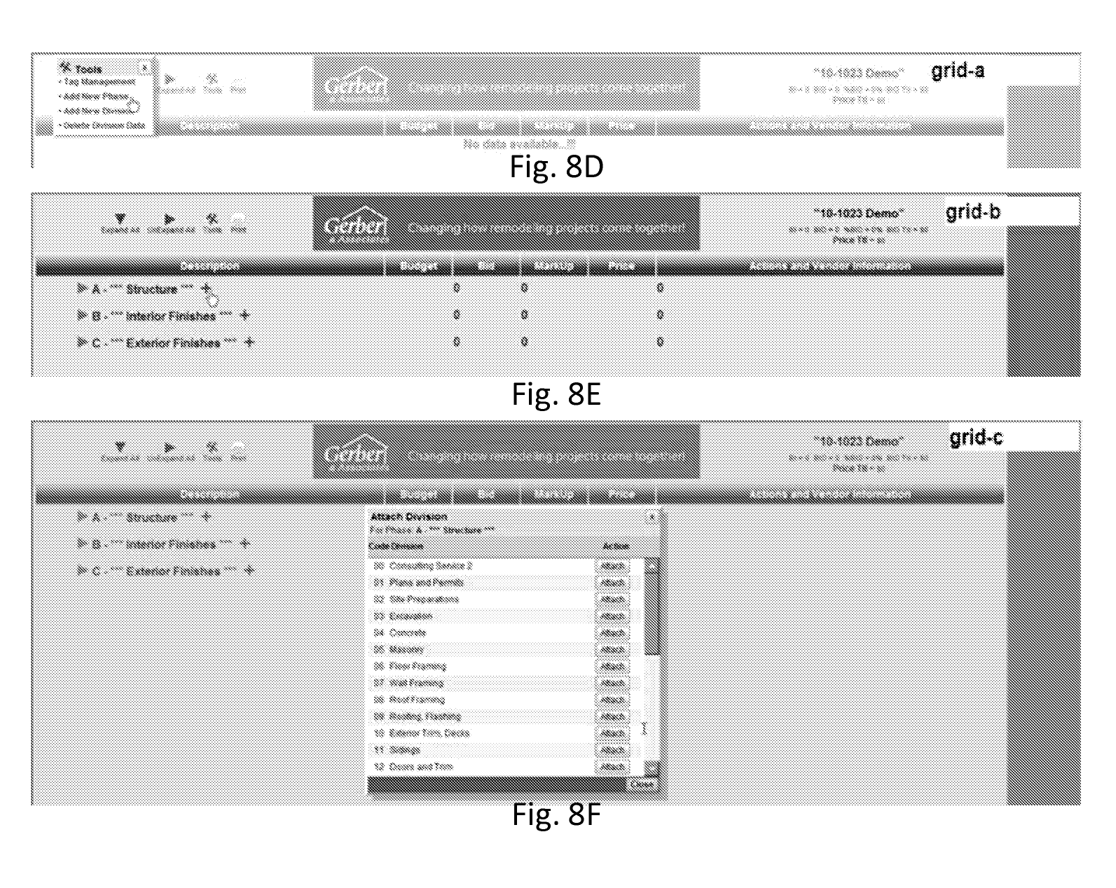

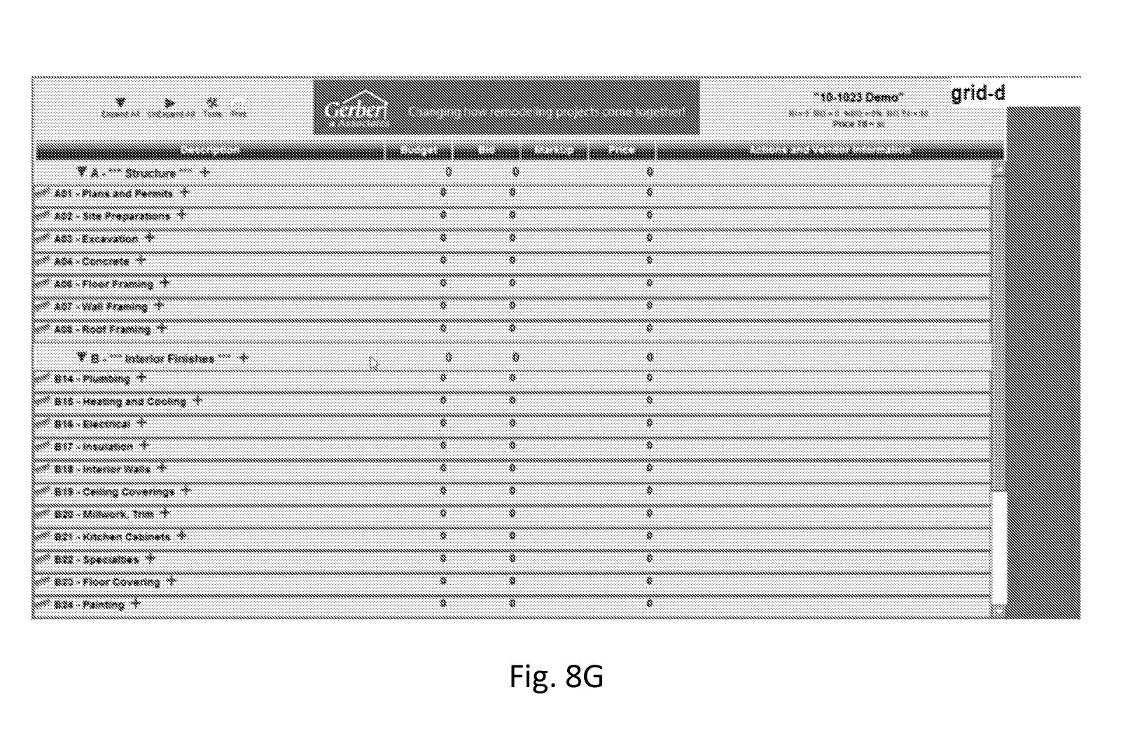

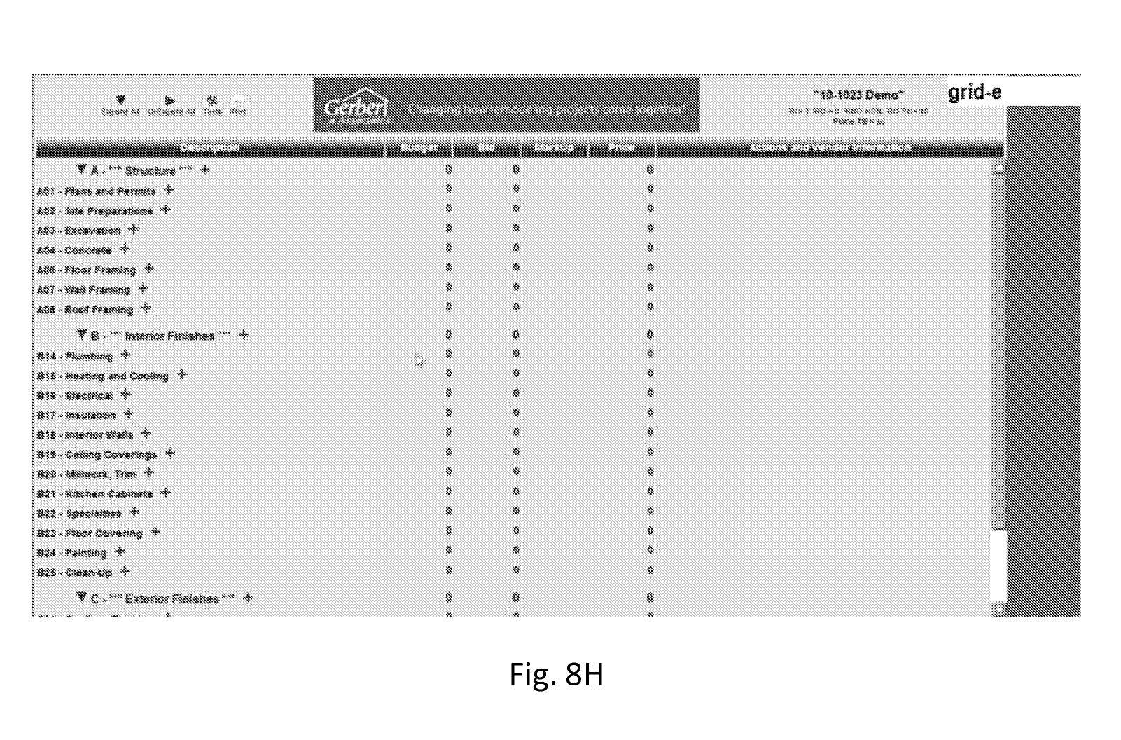

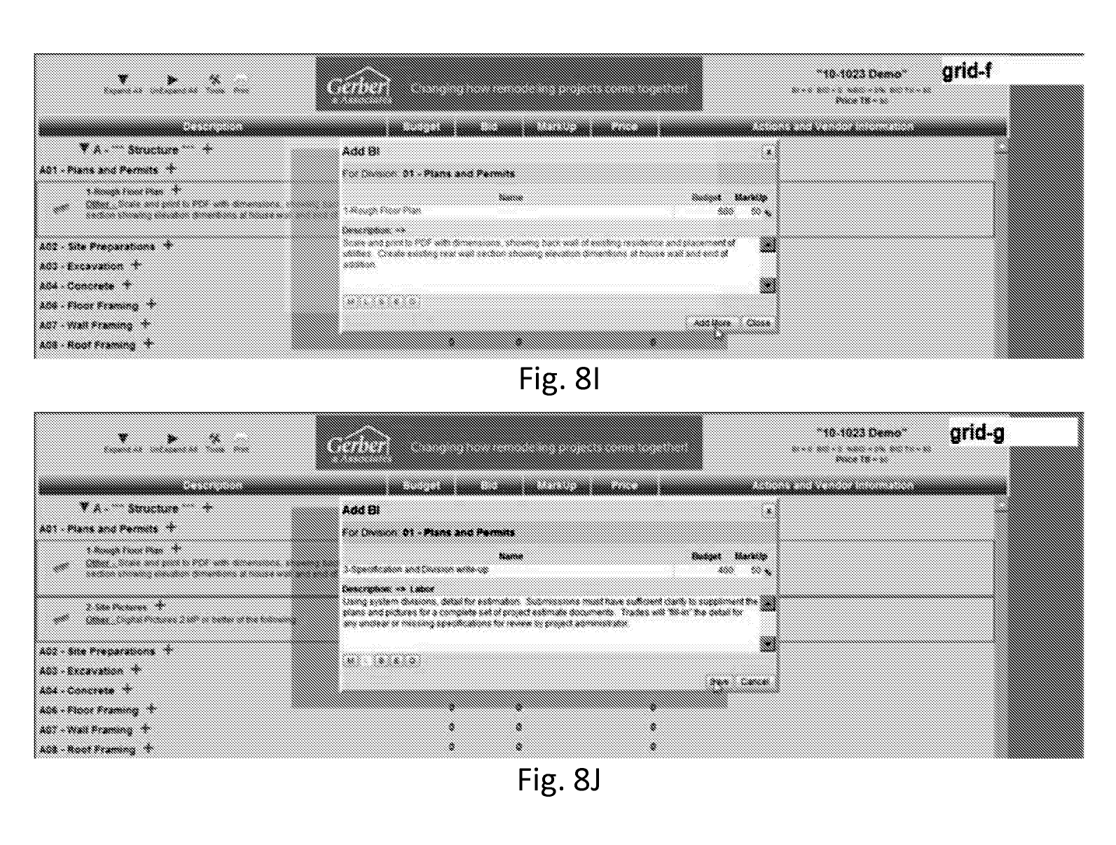

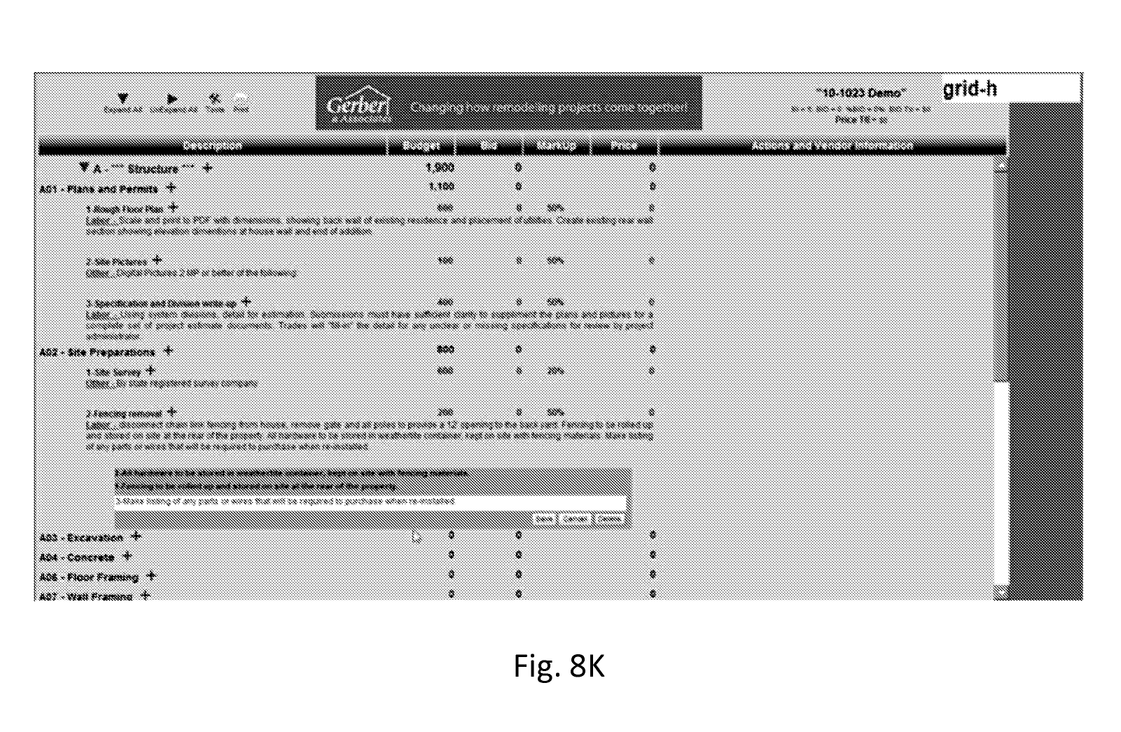

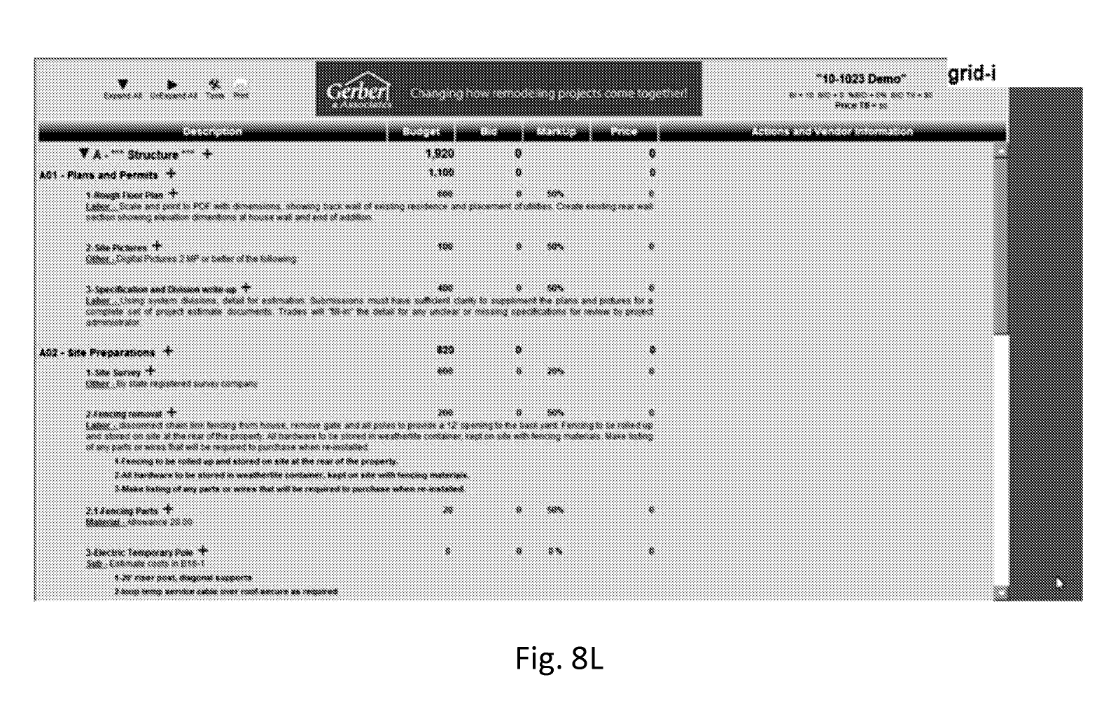

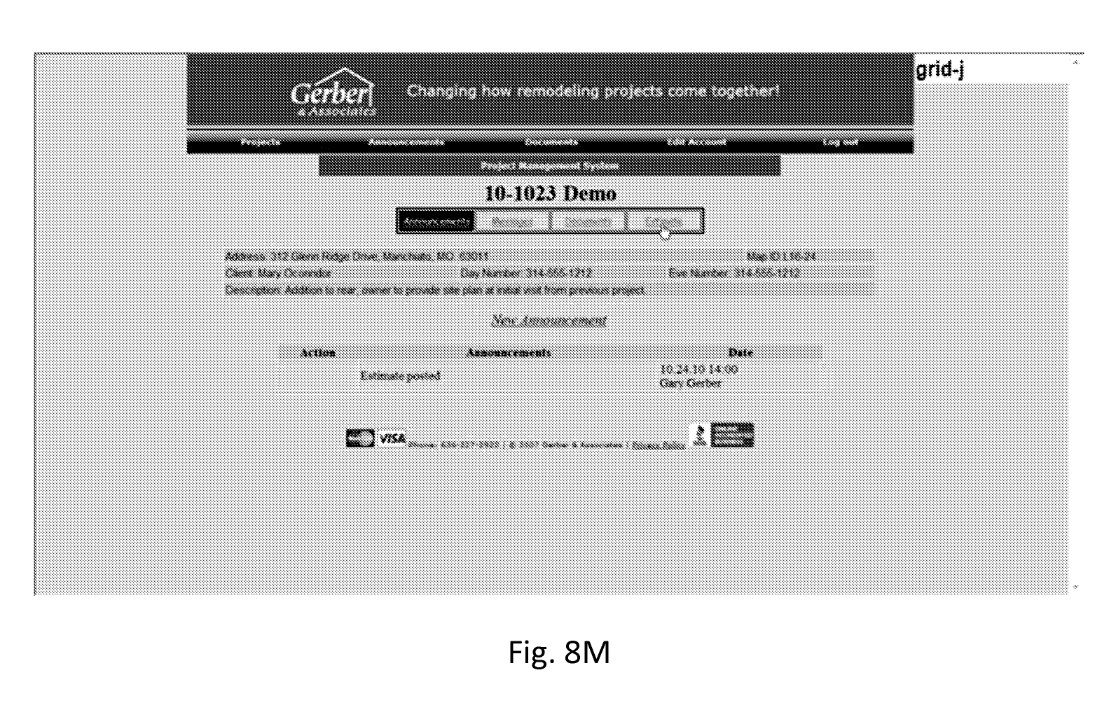

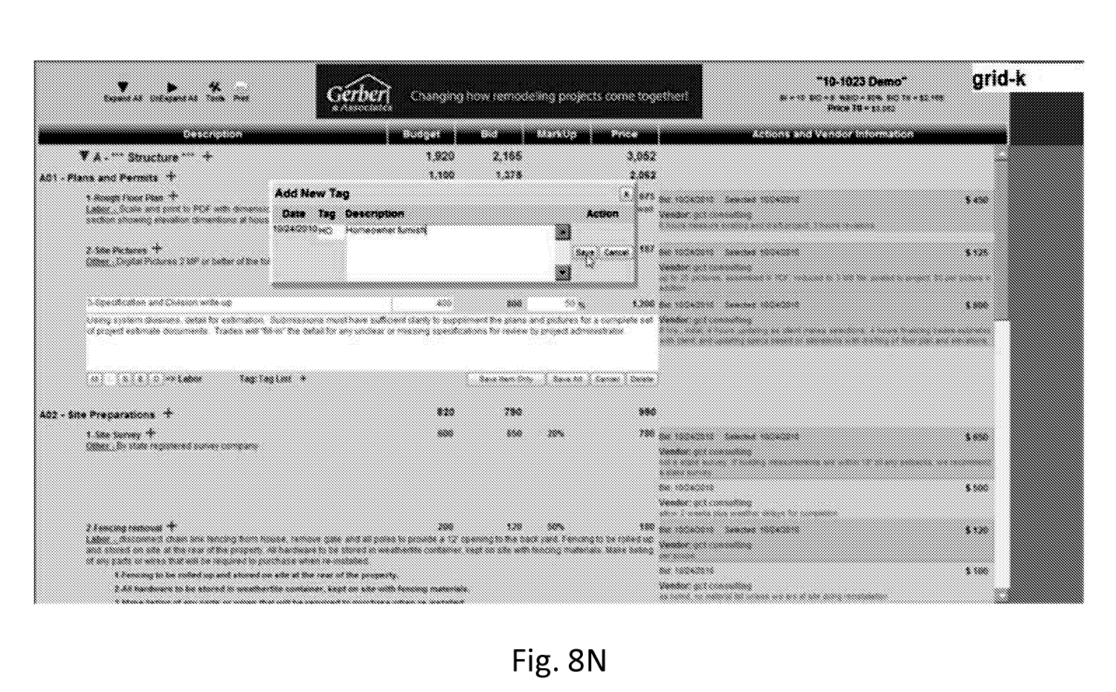

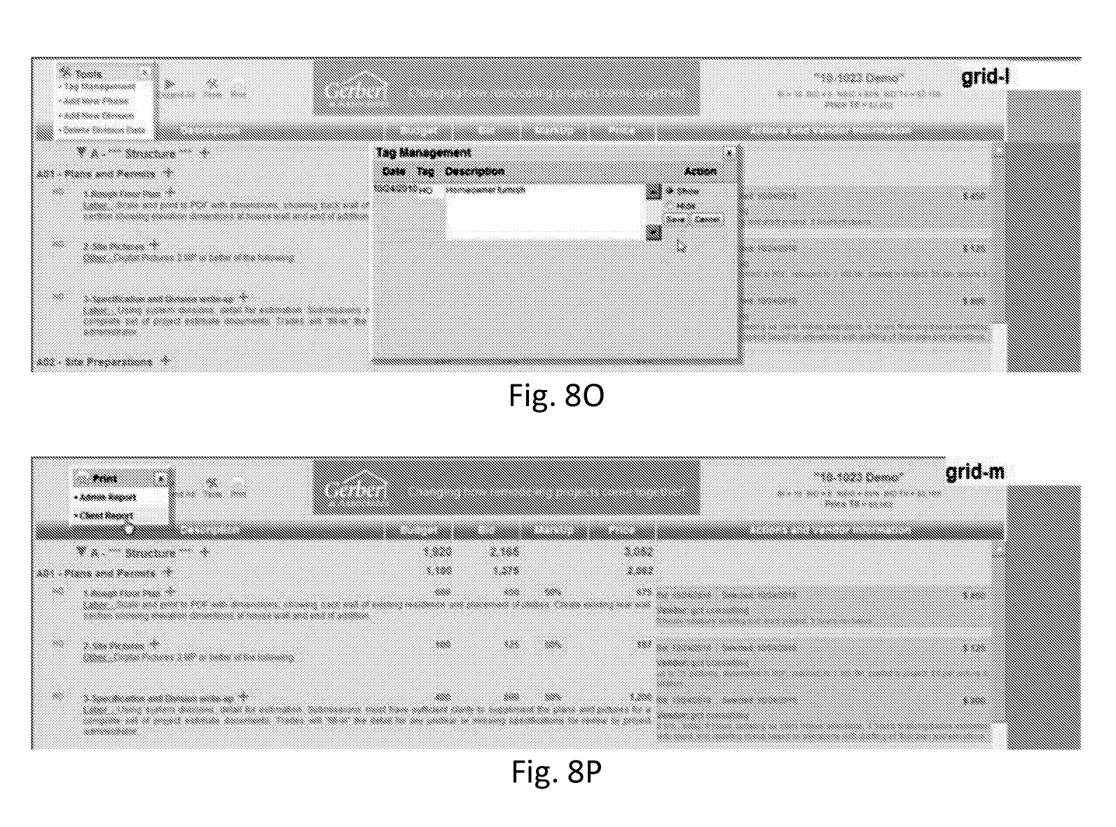

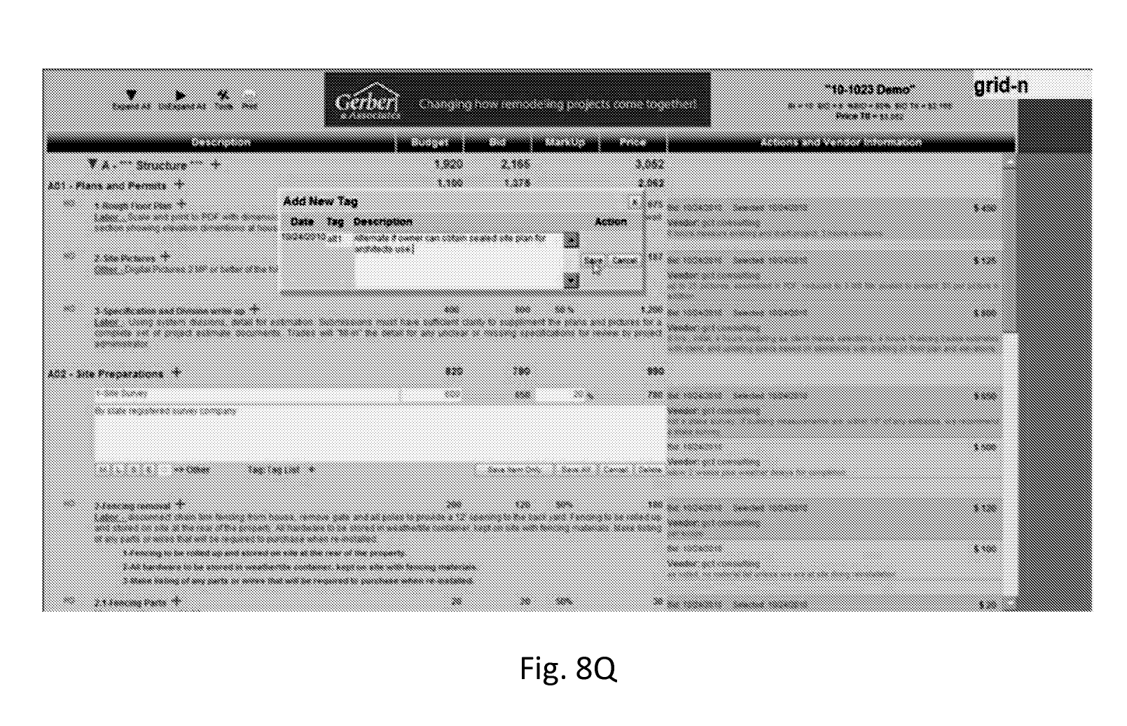

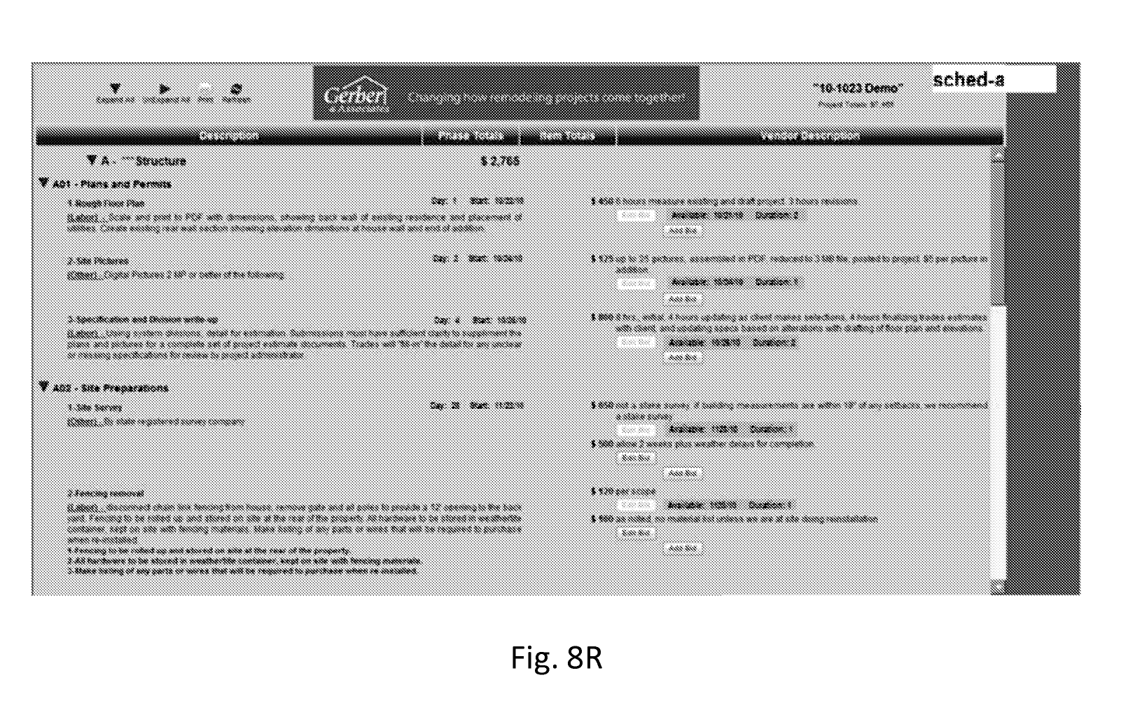

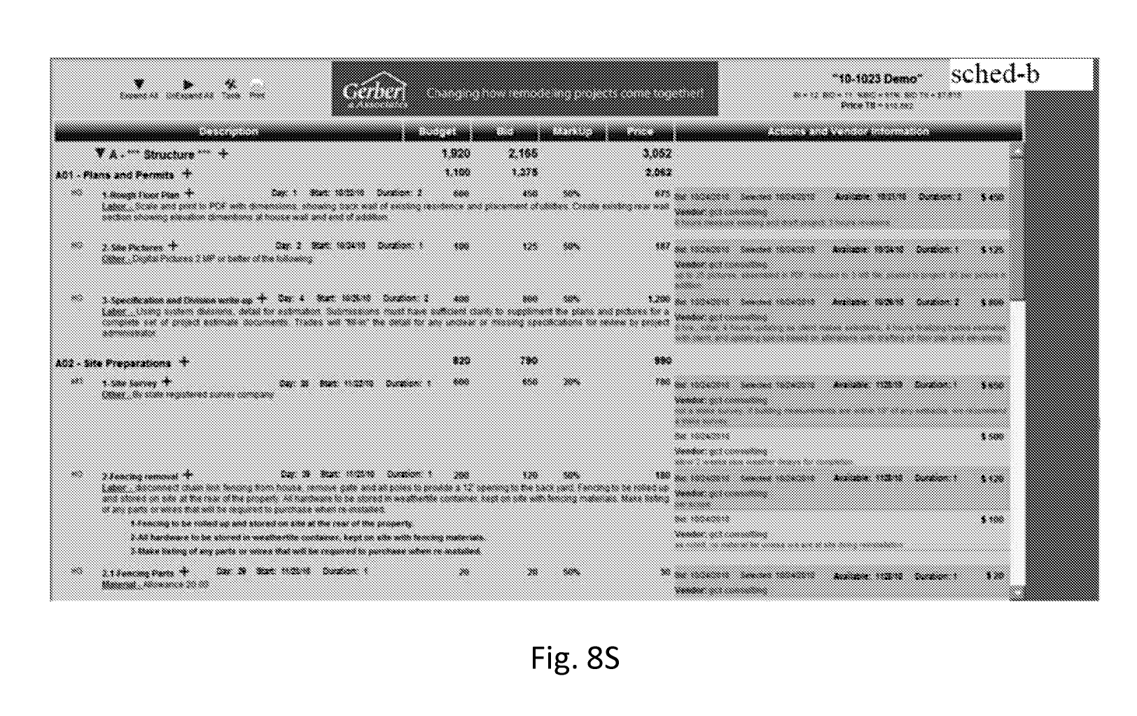

The operation of the system is illustrated with the screen shots of an example project shown in FIGS. 8A-8S (10-1023 Demo) with reference to the description below.

As shown in FIG. 8A, the 10-1023 Demo remodeling project is assigned one client [base-a] with a preselected pricing level. The pricing level selected drives the client screen view. There are five (5) levels of client view generated from the project page.

Members of the project are selected by the checking off boxes [base-b] by a project manager, as shown in FIG. 8B. The project manager or system administrator has access to the estimate design from any project specific page [base-c], FIG. 8C. Project members are professionals, tradesmen, and suppliers, as well as the client. These members are selected from the base program database and invited to examine documents, pictures, and drawings through a series of e-mail and text notifications. Once selected from the base program database, members are able to access the “grid” module by selecting the Estimate link [grid-j], FIG. 8M, and view project specification data, as well as submit an on-line estimate to each biddable item.

Once in the estimator module, the user designs the phases for the project based on how the client can best understand the product offering [grid-a], FIG. 8D. In the 10-1023 Demo case example, a room addition is used as the sample project. The 10-1023 Demo case has three (3) phases [grid-b], FIG. 8E. We will add user definable project divisions by clicking on the +(add) button.

The + selection brings up the listing for selection. As items selected using the attach button, they are added to the particular phase [grid-c], FIG. 8F. The system immediately sends the data to the server, but brings the user back to the screen for a quick review prior to refreshing the screen [grid-d], FIG. 8G. Once the screen is refreshed, the divisions are ready for the next level of detail called Biddable Items, herein referred to as BIs. A BI box is opened by selecting the +button from the project design page [grid-e], FIG. 8H.

Each BI entry box contains a subject name, budget amount, item markup percentage, and a detailed description of the subject item. Each item can here be assigned a category type, which feeds client material selection sheets, labor schedulers for employees or subs furnishing labor only, subs for subcontractors furnishing labor and materials, equipment required, and other for miscellaneous items [grid-f], FIG. 8I. A user selects the Add More button to add another item under the same division [grid-g], FIG. 8J. After all items have been entered, the user selects the Save button to post to the project. All user entry is sent immediately to the server, and the screen is organized in a sorting order when the banner is selected to refresh the screen.

Items are added to a Biddable Item by pressing the + (add) button next to the BI. Items are in addition to the description, and are displayed in list form for additional clarification. When entered, all data is sent to the server and the box is grayed [grid-h], FIG. 8K.

This tells the user that the screen needs to be refreshed for the items to be set in order [grid-i], FIG. 8L.

In addition to the category items in a BI, the user can create tags for a project [grid-k], FIG. 8N. A tag is an item that can be included, or excluded from the project, totals, and screen details by using the tag management feature under the tools menu [grid-1], FIG. 8O. If the Admin user selects the hide button for a tag, the items remain in the project database but are excluded from view on all user screens, as well as their associated values in relation to the project totals. A new tag can be added at any time by selecting the +(add) button adjacent to the Tag List roll-over [grid-n], FIG. 8Q.

Client reports can also be generated from the manager screen under the print menu [grid-m], FIG. 8P. The level of detail in this printout is generated by the client price level from the base software program as described earlier [base-a].

The Contractor module is available for architectural, engineering, and design firms. It is also usable by lumberyards and home centers as a way to have tradesmen estimate projects as they normally would, and then be allowed access as a “Contractor”. This gives the contractor access to the “grid” software, where the user can create schedules and adjust price multipliers as required for his own use.

In the contractor module, the administrator and managers of the project can still oversee the running of the project. This allows a design professional or a home center production manager to oversee the correct implementation of the project and also allows for a contractor to be introduced to the present invention's system prior to having their own system.

It will also be appreciated that the present invention could include modules that allow for a contractor to export his project data out of another user's system into his own.

Scheduling is an add-on system to the Grid Estimating Software [sched-a], FIG. 8R. When selected, it allows the tradesman or supplier to accept a proposed delivery date when submitting an estimate, assuming that there is a schedule set up in the specifications. Once the project manager accepts the bid, it locks the edit bid button and the schedule, price, and specs can't be changed.

A sequence/day number is assigned during the scheduling process. This way, a plumber, electrician, and HVAC contractor can all be scheduled to be on site on the same day. If a duration changes on the tradesmen side, they must resubmit another bid with the revision, or call the administrator to unlock the estimate and change the duration. The administrator screen [sched-b], FIG. 8S, shows all of the schedules and the tradesmen and supplier timeframes. There are user reports under the print icon to see the project in various calendar display formats (gaant and cpm). There is a show all schedules print button that creates an electronic document (e.g. Adobe Acrobat pdf) of all current work in process merged into a single report. This allows the user to stay on top of the various trades and materials deliveries as required. Users can see the current project schedule, or show all of the project schedules of which they are a member.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A project estimator, comprising:
a project database comprising at least one administrator, project information for a plurality of projects, contractor information for a plurality of contractors bidding on said projects, customer information for a plurality of customers purchasing said projects, and estimate information for a plurality of estimates on said projects;
a plurality of phases associated with said projects, wherein each of said projects comprises at least one phase; and
a plurality of divisions associated with said phases, wherein each of said phases comprises at least one division, and wherein at least one of said divisions is related to said estimate information for a corresponding one of said estimates.

2. The invention of claim 1, wherein said project database further comprises summary information and a plurality of electronic documents, wherein said summary information and electronic documents are accessible by said customers and corresponding contractors for their respective projects.

3. The invention of claim 2, wherein said plurality of electronic documents include at least one of project documents and correspondence documents, wherein said project documents and correspondence documents are prepared by and shared between said customers and said contractors.

4. The invention of claim 1, wherein said project information, contractor information, customer information and estimate information are stored on a single database.

5. The invention of claim 4, wherein no manual process is required to coordinate, organize and prepare budget estimates after said project information, contractor information, customer information and estimate information are entered into said single database.

6. The invention of claim 1 further comprising a plurality to include or exclude an item from said estimate.

7. The invention of claim 1 further comprising a single access page for each of said projects, wherein said single access page provides estimate information corresponding to said phases and divisions of a selected project.

8. An improved project estimator of the type comprising a base project program that stores project information in a database for a plurality of projects, customer information for a plurality of customers purchasing said projects, tradesmen information for a plurality of tradesmen bidding on said projects, supplier information for a plurality of suppliers providing supplies for said projects, wherein the improvement comprises:
a plurality of estimates for said projects stored in the database as estimate information; and
a project estimation module comprising a plurality of phases associated with said projects, wherein each of said projects comprises at least one phase and a plurality of divisions associated with said phases, wherein each of said phases comprises at least one division, and wherein at least one of said divisions is related to said estimate information for a corresponding one of said estimates.

9. The invention of claim 8, wherein said project database further comprises summary information and a plurality of electronic documents, wherein said summary information and electronic documents are accessible by said customers and corresponding tradesmen and suppliers for their respective projects.

10. The invention of claim 9, wherein said plurality of electronic documents include at least one of project documents being prepared by at least one of said customers, said tradesmen, or said suppliers or correspondence between said customers, said contractor, and said suppliers.

11. The invention of claim 8, wherein said project information, tradesmen information, supplier information, customer information and estimate information are stored on a single database.

12. The invention of claim 11, wherein no manual process is required to coordinate, organize and prepare budget estimates after said project information, tradesmen information, supplier information, customer information and estimate information are entered into said single database.

13. The invention of claim 8 further comprising a plurality of tags to include or exclude an item from said estimate.

14. The invention of claim 8 further comprising a single access page for each of said projects, wherein said single access page provides estimate information corresponding to said phases and divisions of a selected project.

15. A project estimator, comprising:
a project database comprising a plurality of projects;
a single access page corresponding to one of said projects, the single access page including a contractor screen for a contractor corresponding to said project to provide estimates on said project, an administrator screen for an administrator to review said estimates to provide a budget estimate for said project, and a customer screen for a customer corresponding to said project to review said budget estimate.

16. The invention of claim 15, wherein said project comprises a plurality of phases, each said estimate corresponding to one of said phases, said budget estimate for said project corresponding to a total of said estimates.

17. The invention of claim 16, wherein said project comprises a plurality of phases and each said phase comprises a plurality of divisions, each said estimate corresponding to one of said divisions, said budget estimate for said project corresponding to a total of said estimates.

18. The invention of claim 15, wherein said project database further comprises summary information and a plurality of electronic documents, wherein said summary information and electronic documents are accessible by said customers and corresponding contractors for their respective projects.

19. The invention of claim 15, wherein no manual process is required to coordinate, organize and prepare budget estimates after said estimates are entered into said project database.

20. The invention of claim 15 further comprising a plurality of tags to include or exclude an item from said estimate.
